(19) United States
(12) Patent Application Publication
(10) Pub. No.: US 2014/0229393 A1
(43) Pub. Date: Aug. 14, 2014

(54) IP CONTENT DISCOVERY PLATFORM

(71) Applicants: James E. MALACKOWSKI, Chicago, IL (US); Joshua KAPLAN, Chicago, IL (US); Joel E. LUTZKER, Chicago, IL (US)

(72) Inventors: James E. MALACKOWSKI, Chicago, IL (US); Joshua KAPLAN, Chicago, IL (US); Joel E. LUTZKER, Chicago, IL (US)

(21) Appl. No.: 14/177,686

(22) Filed: Feb. 11, 2014

Related U.S. Application Data
(60) Provisional application No. 61/763,249, filed on Feb. 11, 2013.

(51) Int. Cl. G06Q 50/18; G06Q 10/10

(52) U.S. Cl. CPC G06Q 50/184; G06Q 10/10
USPC 705/310

(57) ABSTRACT

A medium is disclosed that incorporates instructions including: a user interface module that receives from a user a first work-targeting input, the first work associated with intellectual property; an asset identifier module that identifies automatically, based on a relation to the first work-targeting input, the first work; the user interface module receiving, as a first work-adapting input, from the user, an input for adapting, modifying or creating a derivative work from the first work; and an adaptation generator module that generates automatically a record of a grant in rights in the adaptation of the first work according to the first work-adapting input, and provides a report of the grant in the adaptation of the first work to the user.

### CROSS-REFERENCE TO RELATED APPLICATION

The present application claims priority to U.S. Provisional Patent Application No. 61/763,249, filed Feb. 11, 2013, the entire content of which is incorporated by reference herein.

### BACKGROUND

1. Field of the Disclosure

The present disclosure relates to a website, computer system and software platform for intellectual property-protected content discovery, browsing and purchasing and in particular, a platform for creating derivative or collective works in intellectual property.

2. Related Art

Currently, a user must first typically request permission from the copyright owner to obtain a right to use a particular copyrighted work but the full range of works available for licensing may not be readily known. Also known are sites such as Pinterest that allow for metatagging of content that is found on the web and bringing such content to the user's virtual bulletin board.

However, it is difficult for a user to discover a range of intellectual property by topic or category, and then to purchase or license a set of such identified topically-related intellectual property in a convenient and expedited manner. Further, it is difficult for such a user to know what the price of such a set of intellectual property would be, and to know whether it would be lawful to modify or create a derivative or adapted work from such intellectual property assets, or to create a collective work based on such intellectual property assets or portions thereof.

### SUMMARY OF THE INVENTION

A non-transitory data processor-readable medium incorporating instructions executable by the data processor is disclosed. The instructions comprising: a user interface module configured to receive from a first user a first work-targeting input, the first work comprising intellectual property; an asset identifier module configured to identify automatically, based on a relation to the first work-targeting input, the first work; the user interface module configured to receive, as a first work-adapting input, from the first user, an input for adapting the first work; an adaptation generator module configured to generate automatically a record of a grant in rights in the adaptation of the first work according to the first work-adapting input, and to provide a report of the grant in the adaptation of the first work to the first user.

In such a medium, the adaptation generator module may by further configured: to save in memory the adaptation of the first work; to cause display of a representation of the adaptation of the first work to the first user; and to cause display of the representation of the adaptation of the first work to a user unrelated to the first user.

In such a medium, the instructions may further comprise: a price generator module configured to compute automatically a price of the adaptation of the first work based on a value of the first work discounted based on the first work-adapting input, and to cause display of the price to the first user.

In such a medium, the instructions may further comprise: an intellectual property rights tracker configured to record automatically at least one of a sale or a licensing transaction involving the adaptation of the first work to the first user, and to keep track of intellectual property rights interests in the first work.

In such a medium, the instructions may further comprise: a bot module configured to visit a plurality of intellectual property databases, and to index by category a set of intellectual property assets.

In such a medium, the instructions may further comprise: a web crawler configured to visit a plurality internet sites, wherein the asset identifier module identifies the first work, based on the relation to the first work-targeting input, from a set of intellectual property assets indexed according to the visited plurality of internet sites.

In such a medium, the user interface module may be further configured to receive from the first user a second work-targeting input, the second work comprising intellectual property,

the asset identifier module may be further configured to identify automatically, based on a relation to the second work-targeting input, the second work, and

the adaptation generator module may be further configured to generate automatically, as a record of a bundle of rights, a record of a grant of rights in the second work, and to provide a report of the bundle of rights to the first user.

In such a medium, the user interface module may be configured to receive, as a second work-adapting input, from the first user, an input for adapting the second work, and

the adaptation generator module may be configured to generate automatically a record of a grant in rights in the adaptation of the second work according to the second work-adapting input, and to provide a report of the grant to the first user.

The adaptation of the first work may be a derivate copyright work in the first work.

In such a medium, the user interface module may be configured to receive from the first user an indication of a limitation in a scope of rights granted in the adaptation of the first work, and

the adaptation generator module may be configured to generate the record of the grant of the rights in the adaptation of the first work according to the indication of the limitation in the scope of the rights granted, such that the rights granted are subject to the limitation.

Such a limitation may designate a time limitation of the grant, and/or may designates a geographic area limitation of the grant, and/or may designate at least one type of use limitation of the grant, and/or may designate that the grant is only for a single type of use.

Also contemplated is a system that includes such a medium, and further includes: the data processor; and an intellectual property database that includes a set of works.

Also contemplated is a system that includes such a medium, and further includes: the data processor; and an intellectual property rights tracker configured to record automatically at least one of a sale or a licensing transaction involving the grant to the first user, and to keep track automatically of intellectual property rights interests in the first work according to the rights granted.

### BRIEF DESCRIPTION OF THE FIGURES

FIG. 1 illustrates is an illustration of an example of a user interface for finding work, according to an aspect of the present disclosure.

FIG. 2 is a schematic illustration of an example of an IP content providing system and its relationship to other modules, according to an aspect of the present disclosure.

FIG. 3 is a schematic illustration of an example of major components of the IP store application, according to an aspect of the present disclosure.

FIG. 4 is a flow chart of an example of a process provided according to the IP content providing system, according to an aspect of the present disclosure.

### DESCRIPTION OF THE DISCLOSURE

A website, computer system and software platform according to the present disclosure allow a user to discover a range of types of content responsive to the user's search, and the user can browse various types of media that are returned in response to the search criteria. Thus, an important aspect is the focus on content discovery of intellectual property works.

Disclosed are an on-line intellectual property content discovery and purchasing system, as well as a device, a computer product incorporating a software program, and a method therefor. The content can be discovered by a user interested in purchasing the intellectual property rights thereto. “Content” may refer to the work provided in digital form over the Internet or World Wide Web and/or to the work depicted or represented thereby but existing in the brick and mortar “physical” world only or existing elsewhere on the web or in digital form. For example, a person or a small business may be interested in distributing a certain type of intellectual property content and may use the system to find suitable content and then to secure the appropriate licensing rights for distributing the discovered content. Similarly, mid-size enterprises or large businesses, universities and other educational pack creators may seek copyright clearance so as to avoid infringing copyrights held by others.

The system also permits users to create derivative works or collective works based upon other works available for license and to then make those derivative works and collective works available for license through the system

For example, a website may be provided to be accessed by a user and to allow the user to discover content from existing content owners, rights owners, public and private databases and user-generated postings. This discovery by the user visiting the website can be facilitated if the various types of media are indexed. A search engine, for example, may have software agents crawl through the web or can search the web in real time. Various search engine indexing techniques can be used and a fee may be charged for running a search on or otherwise accessing the search engine.

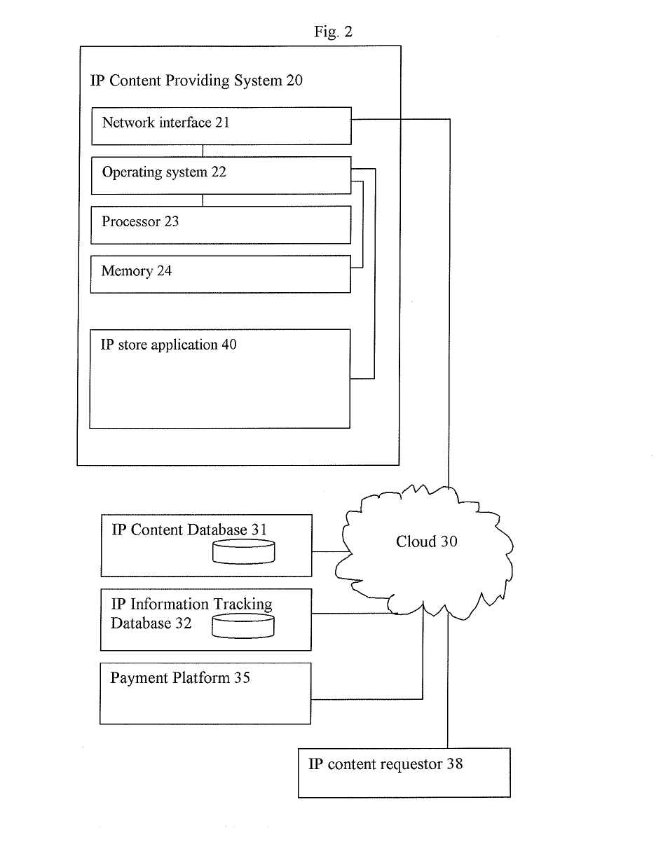

FIG. 2 illustrates an intellectual property content providing system 20 that may be visited by a user, such as a user of IP content requestor 38. By way of illustrative example, FIG. 2 shows that IP content requestor 38 visits IP content providing system 20 via cloud 30. According to this example, IP content providing system 20 may be thought of as a server that provides a website. However, it will be understood that other implementations are possible, for example, IP content requestor 38 may be a module or terminal running on-site or off-site at IP content providing system 20, which may be implemented as software or hardware, as or on a single machine, or as or on a group of machines.

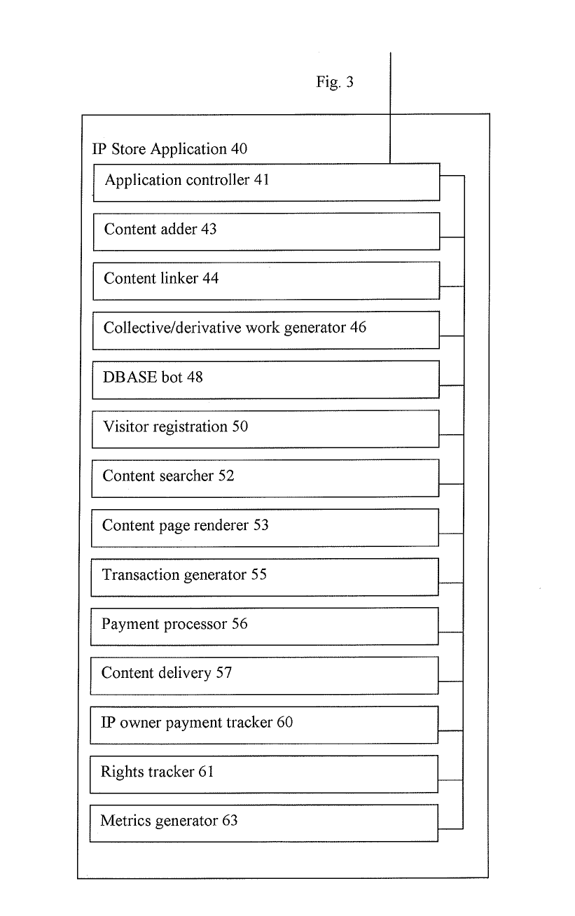

Network interface 21 may be implemented as software, hardware, firmware, or a combination of the foregoing, as may be the other modules illustrated in FIGS. 2 and 3. Network interface 21 may communicate with IP content requestor 38 and with other nodes via cloud 30, for example, using an internet protocol stack approach. Operating system 22 of IP content providing system 20 may run the device that provides the IP content providing system 20. Processor 23 and memory 24 are also provided as part of IP content providing system 20. However, it will be understood that memory 24 and processor 23 may each be provided on more than one chip, and that memory 24 may be located on a different machine or device or on more than one such machine, or may be provided in the cloud.

IP store application 40, also provided as part of IP content providing system 20, is shown in more detail in FIG. 3.

The user visiting the website provided by IP content providing system 20 may register as a user or as a paid subscriber (e.g. monthly paying subscriber) to the site, or may otherwise obtain access to the information provided by the site. In the alternative, the site may provide users free access and charge only when providing relevant hits, or when providing a collective work and/or derivative work, responsive to the user's request. Visitor registration module 50 processes the visitor information and, if necessary, any passwords to obtain access to the system.

The interface provided to the user may depend on the type of user or the user's need in visiting the platform. Individual users or casual buyers may seek a license for a single use, while a corporate buyer may be interested in obtaining a wide reparatory of licenses or rights. Thus, various interfaces or websites may be provided depending on the market segment and branded accordingly.

The user may then provide, or be prompted to provide, an indication of the field or category of a work in which he or she is interested. The person visiting the website may be provided with a graphical user interface that can make accessible the search engine to the user to facilitate the content discovery. For example, the graphical user interface may allow the user to specify search terms and may store filters that the user can select from to specify the type of content that the user wishes to find. For example, a menu of filters can be provided to the user to allow the user to select from the type or types of content in which the user is interested, for example, books, written works, photos, pictures, songs, musical compositions, spoken word, audio books, icons, symbols or the like or from other types of media. In addition, two or more such filters may be selected by the user to restrict further the type of results that the search will return. In addition, Boolean search terms may also be used, date restrictions and date ranges, length restrictions and length ranges and the like. The date restrictions may refer to the date on which the content was added to the current location on the web, the date on which the content was stored in its current location in the real world, the date on which the work was created or published, the date on which the work was uploaded to the web, the date on which the work was sold or licensed or transferred or the like.

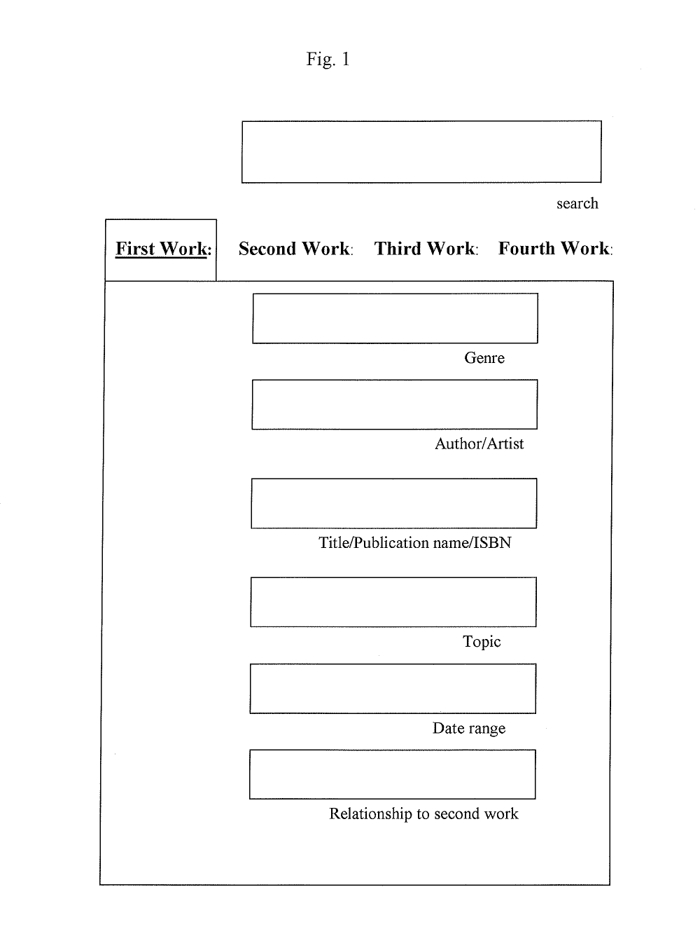

For example, a search text box 71, as illustrated in FIG. 1, may be provided to the user, so that the user can designate one or more search terms. Also, more advanced searching, such as fuzzy logic or Boolean searching allowing the user to designate more than one search term separated by Boolean operators, such as AND, OR, AND NOT, WITHIN SAME SENTENCE, WITHIN SAME PARAGRAPH, WITHIN X NUMBER OF WORDS, WITHIN THE TITLE, WITHIN THE ABSTRACT, WITHIN THE AUTHOR'S NAME, and the like, may also be provided for date ranges, types of work sought, such as photos, graphic art, books, art articles, short stories, paintings, sculptures, mobiles, as well as the field of the work, such as literature, ancient history, Greco-Roman iconography, or the like may also be entered by the user. The user may also be allowed to submit title, artist, writer/author, ISBN number, publication title, publication volume and issue number or other search identifying information. In addition, a combination of such fields and/or identifiers may be submitted. For example, the user may wish to identify a work of art and a short story that will together be used as the underlying works of the collective work or derivative work.

An example of a graphical user interface (GUI) is illustrated in FIG. 1 to allow a user to enter search terms or other work-identifying information. FIG. 1 illustrates a search box 71 that may be provided to allow the user to enter any kind of search term or the title/artist/author of the work or the like. Also shown in FIG. 1 is a more advanced search box 80 that allows the user to specify for each of the works, genre information in genre box 81, to specify a type of work, such as poem, short story, novel, book of non-fiction, photo, film footage newsreel, painting, sculpture, mobile, cartoon or the like, or may allow the user to specify a more specific genre such a comedy or classic movie, European cinema, political cartoon, emoticon, or the like. Creator box 82 allows the user to specify the author, writer, artist, cartoonist, lead actor or other type of work-generator or producer information. Title/publication name/ISBN or other such information that allows the user to enter the title of the work or book, the publication name, the book's ISBN identification, and/or more specific identifier such as volume 17, issue 3, year 1955, page 15 of Life Magazine, or a combination of such information. Topic box 84 allows the user to enter the topic of the work sought, such as “American Bombing of Hiroshima,” Japanese Kabuki theatre of the golden age, blockbuster film posters or the like. The date range allows the user to enter a specific date, or a range of dates, or a start or an end date during which the work was created, first published, first released, or during which the author or artist associated with the work was born, died, was particularly prominent, or the like. It will be understood that other such search boxes may be provided to search for works in different ways and that search boxes shown may be combined.

“Relationship to second work box 86 allows the user to enter the relationship of the first work to the second work sought, for example, same artist, same genre, same time period, same topic but cartoon, same topic and same date range but painting, same song covered by different artist, cartoon of same painting, satire/spook of same film, poster for same movie, or the like. In addition, tabs 89 allow the user to select a second work and to enter information about the second work, and the third work and fourth work in the same manner. In the search fields for the second work, this box would be the relationship to third work box, and so on for the third and the fourth works. The works need not be searched or selected in the order shown, i.e. the second work may be search for or identified before the first work. In addition, the system may provide a list of categories, such as general topics or list of genres or the like to allow the user to choose a topic or genre, and may provide a default date range, or the like rather than to require the user to enter it into a search box. More than four works can be searched and added to the bundle or collective work.

Content searcher 52 then receives this information by the user and provides a list of one or more hits responsive to the user search. The content may be of various types, including books, articles, reviews and other written works, periodicals and publications, anthologies, indexes, collections and collective works, archive contents, songs, albums and musical compositions, paintings, drawings, etchings, photographs and other types of images, news content, films, produced and un-cut video footage, 2D or 3D print designs and mixed media content, software including apps, applets, middleware, scripts, object code and the like, and other types of intellectual property that is copyrighted or copyrightable, published or unpublished. Other types of intellectual property, such as intellectual property protected by sui generis intellectual property protection, including compilations of data and masked works, as well as trademarks, service marks, trade dress or the like may also be thought of as content.

The user can then select one of the hits, and content page renderer 53 will provide an image or other information corresponding to the identified end selected work. The user may enter information for the second work, and content searcher 52 may then search for the work based on the identifying information and provide a list of hits to the user to select from. The user may then select the hit that comes closest to the work he or she was looking for and content page renderer 53 can then provide an image or other identifying information associated with this work.

The user may then specify the works that he or she is interested in purchasing or purchasing rights to, and collective/derivative work generator 46 may then create a collective/derivative work based on the underlying works selected by the user. The user may also select a portion of the work, such as selected pages of a book, short story or publication, or selected paragraphs, lines or sentences thereof, a portion or one or more portions of a drawing or painting or other work of art or a reproduction thereof.

The system may provide software or other tools to allow the user to adapt the work to his or her needs and thus create a derivative work for purchase. For example, the user may be given photo editing and touch-up software, such as Photoshop, film or video content editing tools, such as iMovie, text editing, word processing, or other tools, applications or human services to perform such adaptations, to allow the user to change the appearance of a work or photograph or cartoon or the like or to select portions thereof, or to combine the work with other selected works or portions thereof. The user may then be able to purchase the derivative work he or she generates alone or together with other works of the collective work.

The purchase may be of all the rights in the intellectual property or may be a purchase or a license of the right to access such content one or more times or for a period of time or the right to have customers or business partners access the content one or more times or for a period of time or the like, or to purchase rights to a portion of the content, for example a short video or audio clip or a portion of a written work. The user may be allowed to specify particular rights that the user is interested in purchasing rather than outright purchase of the entire collective/derivative work. For example, the user may be allowed to specify a geographic designation allowing the user to own rights only in one or more particular geographic region or country, or excluding such a region or country, one or more date range during which the user is allowed to have the rights, one or more manner in which the user is allowed to display and/or play the work, such as use in an on-line ad, on a website, in a magazine publication, or in a book, as a display in an art gallery or other display space, performance in a performance space, such as a concert, a bar or an outdoor performance or the like.

In addition, the rights obtained may be limited to display/performance of the collective/derivative works only together with the other underlying works of the collective/derivative work. The grant of rights may be limited to only the user personally, may specify that the user has no right to sell, to alienate or to license other users to do the same, may specify that the user only has a single-use right of the collective/derivative work or any portion thereof, such as a single performance, use in a single on-line ad campaign, in a single performance space, during a single period of time, in a single issue of a magazine publication, or the like, or restrict to a combination of the foregoing, may allow the user to use only the derivative work generated by the user, such as a work adapted by the user, a musical piece that will be covered by another artist in conjunction with other works, or a combination of more than one of the foregoing. Many such other types of IP rights together or alone may be specified in the sale and/or license of the collective/derivative work.

Rights tracker 61 could then keep a record of what rights were granted to the user in the collective/derivative work and what rights are maintained by the owner(s) of the underlying works of the collective/derivative work. Transaction generator 55 would then compute a value for the collective/derivative work based on computation of the value of the underlying works and the scope of the adaptation or derivation work to be granted to the user, as well as based on the type of rights that are being transferred to the user. For example, a single-use right with no right to transfer to others may be charged at a lower rate than a more general license in a work.

Payment processor 56 may be a module that is run as part of IP store application 40. However, it will be understood that payment processor 56 may be payment platform 35, shown in FIG. 2. Payment processor 56 would indicate receipt of payment from the user in IP store application 40. Content delivery 57 would provide an image or other describing information representing the collective/derivative work and the rights therein to be transferred to the user. A license may also be provided that the user would have to indicate acceptance of before completing the transaction.

Also, users and content creators and owners can take advantage of rights bundling, and the system can tend to move the industry for establishing digital, print and performance use standards. An attribute of right management is an appropriate pricing model, which allows rights holders various options for pricing for markets and auctions to bundles per-use and standards-based pricing. The intersection of pricing and rights can determine royalty payments to rights holders and allow for pricing and license models to evolve over time, both maximizing licensees and the royalties obtained by rights owners.

For example, the outright sale price of a work can be discounted based on what portion or portions of the work are being granted, and discounted further based on what rights in the portion or portions are being granted to the user. For example, a user buying the right to reproduce a passage of a novel for a particular date range, could be charged based on the outright value, V, of the copyright in the work, as follows:

V×(0.1+A)×0.01.

This example assumes that the passage to be used is one tenth of the length of the work as a whole, and that A represents a constant that the owner of the IP work will demand no matter what percentage is being used.

Also, this example assumes that the right to use is granted for only one year, and since the copyright term is for life+70, which may be approximated as 100 years, the user is purchasing the rights for 1/100 of the copyright term.

IP owner payment tracker 60 could maintain a record of amounts due to the owners of the rights in the underlying works. For example, each time a collective or derivative work is sold or licensed, IP owner payment tracker 60 would keep a record of how much is due to the owners of the underlying works. Metric generator 63 could also be provided to keep statistics on the types of users that are visiting, the types of rights that are being licensed or sold, the nature of the underlying works, the type of derivative work being generated, the pairings or groupings of works in which rights are being licensed in the same transaction, the times of day/week/year of transactions, the amount of dollars being generated or the like, or combination of such metrics and statistics.

Users of IP content providing system 20 may be directed to a payment system, such as a system that is part of IP content providing system 20 or, as shown in FIG. 2, a separate payment platform 35, which may be a third-party, e.g. credit card, PayPal, debit card, on-line currency, etc., payment platform to allow the user to purchase rights in the content and to record for the rights owners or to transmit to the rights owners the record of the transaction or actual payment for the transaction.

The transaction may be for a complete purchase of the rights by the user, or may be restricted to one or more of a purchase of the right to play, to view, to adapt, to broadcast, to translate, to destroy, to make, to copy or to reproduce, to distribute, to sell, or to allow others to do each of the foregoing, or a combination of the foregoing. The transaction may also be for any other right afforded by the copyright law or other intellectual property law.

The user visiting the website or software platform can identify content across the web using meta-tagging. DBase bot 48 shown in FIG. 3 may create a software agent to crawl websites or databases, and index or sort content stored therein or use mMetatags or other meta elements for such sorting. Images, text or other content may be categorized and retrieved by content adder 43 for later use and discovery. The tag allows content to become searchable using a criterion or a variety of criteria. Also, the result of a search for content can be automatically classified according to what type of content or medium it is or based on the source of the content. Further, the search terms can include such classification of the media sought and/or its source or sources. Such indexing and sorting may be performed in real-time or during off hours. Commercial, government, public private or other databases storing copyrighted or other IP-protected material may also be searched or used to retrieve and to store works for later searching by users.

An interface or an icon representing the IP content providing system may be displayed on existing social platforms, for example, it may be provided as an icon for an existing social networking website or other type of platform, or as component of existing software applications. For example, a business that frequently needs to obtain intellectual property licenses may incorporate an icon or a box with one or more search boxes of the type shown in FIG. 1 or the like in a browser on the partner's internal computer system or network or the like, or the platform can be installed as a software as a service (Saas model) as the “back office” platform solution for current licensing businesses.

The platform can process financial transactions for both purchasing and selling the intellectual property rights. Back office financials to external parties can also be included in the platform, for example, standard integration capability allowing the data to be exported to partners and customer systems. International business can also be supported through multi-currency and VAT support. (Smart) pricing model can be provided, and package pricing may also be made available to users who combine content purchases in distinct bundles.

The content distribution can be handled using digital delivery of the content from content owners or can be handled using a global output partner. Content creators, rights owners, and rights aggregators who wish to monetize intellectual property can have a vehicle for secure monetization of their IP. An efficient transaction and record keeping system can be provided to handle all types of intellectual property, and digital security features can be used to ensure compliance with applicable law and the terms of use by the users.

Rights management capabilities can be billed to support international needs from the start. New regions can be added over time. The platform can support multiple use and content types and can track usage through media specific approaches, such as watermarking, and using compliance and investigation tools.

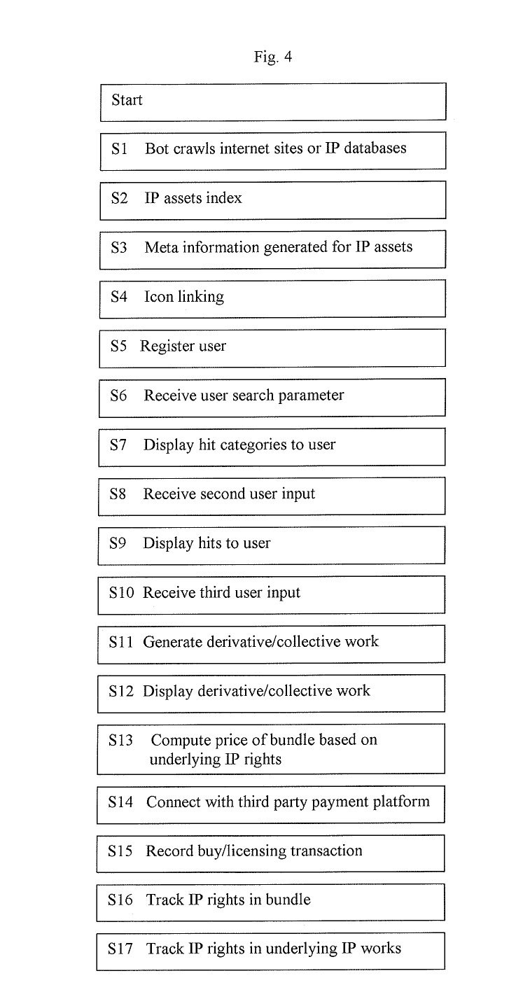

A flow chart of an operation of a system according to an aspect of the present disclosure is illustrated in FIG. 4. After start in FIG. 4, a bot may crawl through internet sites or scour IP databases and catalog or index information stored thereon. At S2, IP assets or works are indexed. At S3, Meta information, such as Meta tags may be generated or retrieved for each IP asset or for each site, or information may be stored in a local database. S4 illustrates that icons representing the IP content providing system 20 may be posted at sites that may use the system. These icons can be linked to the site maintenance for the system using hyperlinking. Similarly, search boxes or search interfaces illustrated in FIG. 1 may be provided on various sites.

At S5, a user interested in using the services may register with the site provided by IP content providing system 20. For example, a user may become a monthly subscriber, paying subscription fees by day, month, year or the like, and such fees may be paid in addition to or instead of a fee for each collective or derivative work received. Alternatively, the user may simply register on the site for free without becoming a subscriber. At S6, the user provides search parameters, for example, according to the GUI illustrated in FIG. 1. Hits representing responses to the search parameters is illustrated at S7. Categories representing sets of works may also be shown to the user or may be shown to the user instead of hits for specific works.

At S8, a second user input may be received, the second input targeting or attempting to find a second work. At S9, the hits for the second user input are displayed to the user.

At this point, the user may be prompted to create an adaptation or derivative work based on the first or second work. For example, the user may designate one or more portions of a book or one or more portions of a graphic work, such as a painting or cartoon or sculpture or film, or it may change the appearance of such a graphic work to generate the adaptation. At S10, this third user input is received, and at S11 the system generates a derivative/collective work. This is then displayed at S12 to the user.

At S13, the bundle of rights to be granted to the user is computed, for example, based on the value of the underlying IP rights. Such values may be discounted based on the adaptation, and based on other limitations in the grant specified by the user.

At S14, a third-party payment platform may be used to charge the user for the price of the bundle.

At S15, the system records the buy/licensing transaction in the bundle of rights granted, and at S16, the system tracks IP rights in the bundle for later retrieval. At S17, the system tracks IP rights in the IP works that underlie the bundle. For example, a first work used to create the adaptation by the user is an underlying IP work. The owner of the first work could then be contacted of the grant and could be compensated according to the grant to the user or based on flat fee arrangement. Alternatively, the owner of the first work may be granted a set price for registering the first work with the system as a lump sum payment, or the first work's owner can be compensated for each day or each month or some other period of time during which the first work is listed with the site and available for users of the IP content providing system 20.

Instead of, or in addition to, a fee for each asset or collective work/derivative work, a user can pay a one-time royalty for rights transacted through the platform, or can pay a royalty on a regular basis for a period of time, or a royalty for each time a work is viewed, played, used, reproduced, distributed, translated, sold or the like, or is used as a combination of the foregoing.

The platform can also support local catalogs defined by country or by rights region. Custom product bundles and bundle pricing can also be provided. For example, bundling of rights for a number of pieces of content in which rights are sold or licensed, or for a number of countries or number of regions in which such rights are sold.

The platform can be provided using an open source software approach or using proprietary technologies or a combination of open source, proprietary and off-the-shelf technologies. The software can be built using a modular approach or using an object-oriented paradigm to support continued expansion of content types and associated search technologies. The platform can be highly integrated, supporting financial institutions for transaction processing, API's for extensibility, and data exports for large customers and partners. The program to support the platform can be implemented as hardware, software, firmware or as a combination of the foregoing and can reside on one or more servers or premises or in the cloud.

The present methods, functions, systems, computer-readable medium product, or the like may be implemented using hardware, software, firmware or a combination of the foregoing, and may be implemented in one or more computer systems or other processing systems, such that no human operation may be necessary. One or more software applications providing the functionality herein described may be provided by a server or server bank in the cloud or on a proprietor's premises, or may be downloaded to a computer or portable device of the user to make possible the delivery of patent or patent application value to a requesting user.

The methods and functions can be performed entirely automatically through machine operations, but need not be entirely performed by machines. Similarly, the systems and computer-readable media may be implemented entirely automatically through machine operations but need not be so. A computer system may include one or more processors in one or more units for performing the system according to the present disclosure and these computers or processors may be located in a cloud or may be provided in a local enterprise setting or off premises at a third party contractor, and may communicate with a user requesting IP content, IP rights or information about the foregoing on site via a wired or wireless connection, such a through a LAN or WAN, or off site via internet protocol-enabled communication, via a cellular telephone provider or via other such means. Similarly, the information stored and/or the patent database from which the sets of data are extracted, may be stored in a cloud, in an official or third party patent information database, or may be stored locally or remotely. The computer system or systems that enable the user to interact with content or features can include a GUI (Graphical User Interface), or may include graphics, text and other types of information, and may interface with the user via desktop, laptop computer or via other types of processors, including handheld devices, telephones, mobile telephones, smart phones or other types of electronic communication devices and systems. A computer system for implementing the foregoing methods, functions, systems and computer-readable storage medium may include a memory, preferably a random access memory, and may include a secondary memory. Examples of a memory or a computer-readable storage medium product include a removable memory chip, such as an erasable programmable read-only memory (EPROM), a programmable read-only memory (PROM), removable storage unit or the like.

The communication interface of system shown in FIG. 2 may include a wired or wireless interface communicating over TCP/IP paradigm or other types of protocols, and may communicate via a wire, cable, fire optics, a telephone line, a cellular link, a satellite link, a radio frequency link, such as WI-FI or Bluetooth, a LAN, a WAN, VPN, the world wide web or other such communication channels and networks, or via a combination of the foregoing.

While the preferred embodiments of the invention have been illustrated and described, modifications and adaptations, and other combinations or arrangements of the structures and steps described come within the spirit and scope of the application and the claim scope.

What is claimed is:

1. A non-transitory data processor-readable medium incorporating instructions executable by the data processor, the instructions comprising:
a user interface module configured to receive from a first user a first work-targeting input, the first work comprising intellectual property;
an asset identifier module configured to identify automatically, based on a relation to the first work-targeting input, the first work;
the user interface module configured to receive, as a first work-adapting input, from the first user, an input for adapting the first work; and
an adaptation generator module configured to generate automatically a record of a grant in rights in the adaptation of the first work according to the first work-adapting input, and to provide a report of the grant in the adaptation of the first work to the first user.

2. The medium of claim 1, wherein the adaptation generator module is further configured:
to save in memory the adaptation of the first work;
to cause display of a representation of the adaptation of the first work to the first user; and
to cause display of the representation of the adaptation of the first work to a user unrelated to the first user.

3. The medium of claim 1, wherein the adaptation generator module is further configured:
to save in memory the adaptation of the first work;
to cause display of a representation of the adaptation of the first work to the first user; and
to cause display of the representation of the adaptation of the first work to a user unrelated to the first user, the instructions further comprising:
an intellectual property rights tracker configured to record automatically at least one of a sale or a licensing transaction involving the adaptation of the first work to the first user, and to keep track of intellectual property rights interests in the first work.

4. The medium of claim 1, wherein the instructions further comprise:
an intellectual property rights tracker configured to record automatically at least one of a sale or a licensing transaction involving the adaptation of the first work to the first user, and to keep track of intellectual property rights interests in the first work.

5. The medium of claim 1, wherein the instructions further comprise:
a bot module configured to visit a plurality of intellectual property databases, and to index by category a set of intellectual property assets.

6. The medium of claim 1, wherein the instructions further comprise:
a web crawler configured to visit a plurality internet sites,
wherein the asset identifier module identifies the first work, based on the relation to the first work-targeting input, from a set of intellectual property assets indexed according to the visited plurality of internet sites.

7. The medium of claim 1, wherein the user interface module is further configured to receive from the first user a second work-targeting input, the second work comprising intellectual property,
the asset identifier module is further configured to identify automatically, based on a relation to the second work-targeting input, the second work, and
the adaptation generator module is further configured to generate automatically, as a record of a bundle of rights, a record of a grant of rights in the second work, and to provide a report of the bundle of rights to the first user.

8. The medium of claim 1, wherein the user interface module is configured to receive, as a second work-adapting input, from the first user, an input for adapting the second work, and
the adaptation generator module is configured to generate automatically a record of a grant in rights in the adaptation of the second work according to the second work-adapting input, and to provide a report of the grant to the first user.

9. The medium of claim 1, wherein the adaptation of the first work is a derivate copyright work in the first work.

10. The medium of claim 1, wherein the user interface module is configured to receive from the first user an indication of a limitation in a scope of rights granted in the adaptation of the first work, and
the adaptation generator module is configured to generate the record of the grant of the rights in the adaptation of the first work according to the indication of the limitation in the scope of the rights granted, such that the rights granted are subject to the limitation.

11. The medium of claim 10, wherein the limitation designates a time limitation of the grant.

12. The medium of claim 10, wherein the limitation designates a geographic area limitation of the grant.

13. The medium of claim 10, wherein the limitation designates at least one type of use limitation of the grant.

14. The medium of claim 10, wherein the limitation designates that the grant is only for a single type of use.

15. A system comprising the medium of claim 1, and further comprising:
the data processor; and
a portal configured to access an intellectual property database that includes a set of works.

16. A system comprising the medium of claim 1, further comprising:
the data processor; and
an intellectual property rights tracker configured to record automatically at least one of a sale or a licensing transaction involving the grant to the first user, and to keep track automatically of intellectual property rights interests in the first work according to the rights granted.

17. An intellectual property adaptation system including a data processor, the system comprising:
a user interface module configured to receive from a first user a first work-targeting input, the first work comprising intellectual property;
an asset identifier module configured to identify automatically, based on a relation to the first work-targeting input, the first work;
the user interface module configured to receive, as a first work-adapting input, from the first user, an input for adapting the first work; and
an adaptation generator module configured to generate automatically a record of a grant in rights in the adaptation of the first work according to the first work-adapting input, and to provide a report of the grant in the adaptation of the first work to the first user.

18. An intellectual property adaptation method comprising:
receiving, via a user interface module executed on a data processor, from a first user, a first work-targeting input, the first work comprising intellectual property;
identifying automatically based on a relation to the first work-targeting input, the first work;
receiving, via the user interface module, as a first work-adapting input from the first user, an input for adapting the first work;
generating automatically a record of a grant in rights in the adaptation of the first work according to the first work-adapting input; and
providing automatically a report of the grant in the adaptation of the first work to the first user.
